(19) United States
(12) Patent Application Publication
(10) Pub. No.: US 2012/0117855 A1
(43) Pub. Date: May 17, 2012

(54) Jug-a-bug

(76) Inventor: Frank N. Miller, Naples, FL (US)

(21) Appl. No.: 13/068,565

(22) Filed: May 16, 2011

Related U.S. Application Data
(60) Provisional application No. 61/414,888, filed on Nov. 17, 2010.

(51) Int. Cl. A01M 1/10

(52) U.S. Cl. 43/121

(57) ABSTRACT

A roach trap known as the Jug-A-Bug 1 comprises a container 2 with peripheral walls defining an interior space 6, a bottom wall 3 with protuberances 4 defining a bait basin 5, a neck portion 7 and threaded portion 8 capable of mating with the threaded section 10 of restrictive lid 9 and having a closure disk 13; the bait basin 5 contains a bait and the interior space 6 contains a viscous fluid whereby roaches are lured into the container by the bait and confined in the interior space 2 by the combination of the viscous fluid and the contours of the restrictive lid 9.

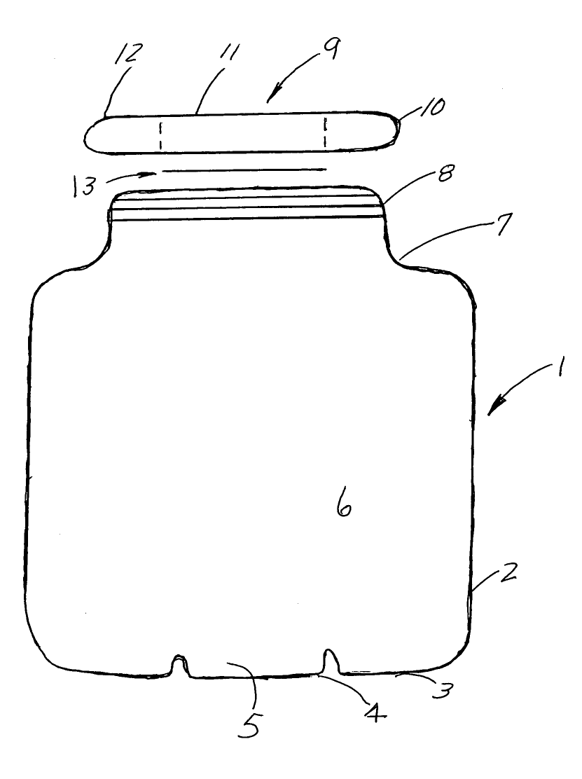

### CROSS REFERENCE TO RELATED APPLICATIONS

This application is based on U.S. Provisional Application U.S. 61/414,888 filed on Nov. 17, 2010.

### FEDERALLY SPONSORED RESEARCH

None

### SEQUENCE LISTING

None

### BACKGROUND OF THE INVENTION

My invention relates to a trap for crawling insects, particularly for cockroaches, which tend to infest dwellings as well as commercial establishments such as restaurants and are considered highly resourceful in avoiding all kinds of traps set for them. They are on the other hand known to take chances in order to get at supplies of food, despite their limited ability to move through the air by jumping or flying. Because of the highly developed instincts attempts to lure them to their death with poisoned foodstuffs have been largely proved futile.

### SUMMARY OF THE INVENTION

It is general object of the invention to provide a trap for cockroaches and similar vermin which is of simple construction and reliable in operation.

A more particular object is to provide a cockroach trap which does not contain any substances that could be harmful to humans (including children) coming into contact therein, i.e. is non-poisonous.

A related object is to provide means in such trap for facilitating the removal of its contents and its subsequent reuse.

I have found, in accordance with the present invention, that an efficient trap for crawling insects—especially cockroaches—can be constructed as an upright jug-shaped unitized clear plastic container having peripheral side walls, a bottom wall with integrally shaped protuberances defining a bait basin, and a threaded upper neck portion and a restrictive lid having a threaded section capable of mating with the threaded upper neck portion. The jug-shaped unitized clear plastic container can be manufactured as a single unit and can be blown into any desired shape.

Another advantage of the instant invention is the non poisonous food substances used as bait including ground cinnamon, molasses, mashed potatoes, vanilla, ground cloves, blue cheese, white sugar, chicken soup base, pickle juice as well as mixtures thereof.

Another advantage of the instant invention is the non poisonous viscous fluid used to retard the movement of the roaches once they enter the trap including vegetable oil, canola oil, olive oil, peanut oil as well as mixtures thereof.

Another advantage of the instant invention is the combination of the contours of the trap and the restrictive lid design. To exit the trap a roach must navigate these hurdles upside down. The roach having slippery feet due to contact with the viscous fluid within the trap interior cannot accomplish this and falls back into the trap. A feature of the restrictive lid is if the trap is tipped over, no fluids will spill out.

Another advantage of the instant invention is the unique design of the restrictive lid. It is circular in shape and has an opening therein. A closure disk is provided to close the opening when the trap is in transit and not in use. The restrictive lid defines a peripheral lip around the opening which creates a damming feature to stop fluid egress if the trap is tipped over and it creates an impediment to the roaches egress because the roach would have to climb around the peripheral lip thereof.

The novel features which are considered a characteristic of the invention are set forth in particular in the appended claims. The invention itself, however, both as to construction and its method of operation, together with additional objects and advantages thereof, will be best understood from the following description of specific embodiments when read in connection with the accompanying drawings.

### BRIEF DESCRIPTION OF THE DRAWING

The FIGURE is an overall view of the unitized clear plastic container known as the Jug-a-Bug.

### DESCRIPTION OF THE PREFERRED EMBODIMENT

The Jug-a-Bug roach trap 1 is made as a singular unitized clear plastic container 2 having peripheral side walls, a bottom wall 3 with protuberances 4 defining a bait basin 5, an interior space 6 provided to contain a viscous liquid such as vegetable oil or the like. The container 2 has a neck portion 7 which is threaded 8 and capable of mating with the threaded section 10 of restrictive lid 9. The restrictive lid 9 has an opening 11 therein and a closure disk 12 for closing the trap during transit and storage. The relative dimensions of the restrictive lid 9 are designed such that threaded section 10 mates with the threaded portion 8 of the neck portion 7 of the container 2. The opening 11 is dimensioned such that a peripheral lip 12 of the restrictive lid 9 overhangs the interior of the container 2 and provides a contour that hinders the escape of the roach from the container.

### NUMERALS

1 Jug-A-Bug

2 container

3 bottom wall

4 protuberances

5 bait basin

6 interior space

7 neck portion

8 threaded portion

9 restrictive lid

10 threaded section

11 opening

12 peripheral lip

13 closure disk

### OPERATION

To set the cockroach trap known as the Jug-A-Bug a person would remove the restrictive lid 9 and remove the closure disk 12 therefrom. A small amount of bait would be deposited into the bait basin 5 and a small amount of viscous liquid would be deposited into the interior space 6. The restrictive lid 9 would be replaced and the Jug-A-Bug would be placed in the area where cockroaches would be present. As the roaches are attracted to the bait, they would climb up the outer wall of the container and fall through the opening in the restrictive lid. They would come into contact with the viscous fluid within the interior space 6 of the container 2 thereby making their legs slippery and impeding their ability to climb up the interior walls of the container where they would encounter the restrictive lid and have to walk upside down to exit the container and thereby fall back into the container 2 where they will die.

In order to remove the dead cockroaches from the Jug-A-Bug a person only has to remove the restrictive lid 9 and turn the trap upside down causing them to fall out of the trap. They could be flushed down the toilet or deposited in some other removal system. The bait and viscous fluid can now be reinserted into the container 2 and the Jug-A-Bug is ready for action again.

To clean the Jug-A-Bug one could deposit about four cups of soapy water and possibly a little bleach. One would close the lid 9 with the closure disk 12 repositioned and shake the cleaning fluid before emptying the solution. The container 2 is capable of being cleaned in the dishwasher.

1. A device for trapping crawling insects comprising:
a unitized clear plastic container having peripheral side walls and having upper ends, a bottom wall having at least two protuberances integrally formed therein and defining a bait basin, a threaded neck portion formed at the upper ends of the peripheral walls, a restrictive lid having an opening therein and having a threaded section designed to mate with the threaded neck portion of the container, a peripheral lip positioned about said opening, said interior space defining an insect capturing chamber positioned about the bait basin, said interior space adapted to contain a viscous liquid, said bait basin adapted to receive bait, whereby crawling insects are attracted to the bait and enter the opening in the restrictive lid and fall into the interior space of the container and contact the viscous liquid thereby retarding their ability to climb up the side walls and out through the opening in the restrictive lid and around the peripheral lip.

2. The device of claim 1, further including a closure disk positioned within the threaded section of the restrictive lid for closing the opening therein.

3. The device of claim 1, further including a bait positioned within said bait basin and selected from the group consisting of ground cinnamon, molasses, mashed potatoes, vanilla, ground cloves, blue cheese, white sugar, chicken soup base, pickle juice and mixtures thereof.

4. The device of claim 3, further including a viscous solution positioned within the interior space and selected from the group consisting of vegetable oil, canola oil, peanut oil, olive oil, corn oil and mixtures thereof.

5. The device of claim 1, further including a viscous solution positioned within the interior space and selected from the group consisting of vegetable oil, canola oil, peanut oil, olive oil, corn oil and mixtures thereof.
